(19) United States
(12) Patent Application Publication
(10) Pub. No.: US 2025/0251715 A1
(43) Pub. Date: Aug. 7, 2025

(54) SYSTEMS AND METHODS FOR CONTAINERIZED DISTRIBUTED PROCESS CONTROL

(71) Applicant: Rockwell Automation Technologies, Inc., Mayfield Heights, OH (US)

(72) Inventors: Michael J. Anthony, Milwaukee, WI (US); David A. Johnston, Painesville, OH (US); Kyle E. Neet, Northfield, OH (US); Paul Brooks, Everberg (BE); Clark L. Case, Aurora, OH (US); Douglas B. Sumerauer, Concord Township, OH (US); Kevin A. Fonner, North Canton, OH (US); Steven J. Pinard, Mayfield Village, OH (US); Taryl J. Jasper, Concord Township, OH (US); Charles M. Rischar, Chardon, OH (US)

(21) Appl. No.: 18/430,200

(22) Filed: Feb. 1, 2024

(51) Int. Cl. G05B 19/4155; G06F 13/20

(52) U.S. Cl. CPC G05B 19/4155; G06F 13/20; G05B 2219/31368; G06F 2213/40

(57) ABSTRACT

A method includes generating, via a containerized control application executing in a container running on computing infrastructure, a command that defines at least one characteristic of an operation of an industrial automation device in performance of an industrial automation process, transmitting the command from the containerized control application to an input/output (I/O) proxy, wherein the I/O proxy is configured to interface between the containerized control application and a physical I/O, transmitting the command from the I/O proxy to the physical I/O, wherein the physical I/O is configured to receive data from the industrial automation device and provide commands to the industrial automation device, transmitting the command from the physical I/O to the industrial automation device, and implementing, via the industrial automation device, the command.

### BACKGROUND

The present disclosure generally relates to process control for industrial automation devices.

Industrial automation systems may be used to provide automated control of one or more industrial automation devices (e.g., including one or more actuators) in an industrial setting. Implementing process control for the one or more industrial automation devices using dedicated operational technology (OT) hardware, such as one or more industrial automation controllers, may be inflexible and inefficient to scale quickly. An enterprise's process control capabilities are dictated by the capabilities of the OT hardware it has at its disposal and how that OT hardware is configured. Accordingly, adding or changing the enterprise's process control capabilities may require acquiring more OT hardware and/or reconfiguring the OT hardware on hand, which may be time and resource intensive. Accordingly, new techniques for industrial automation process control that are more flexible and more scalable are desired.

This section is intended to introduce the reader to aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes generating, via a containerized control application executing in a container running on computing infrastructure, a command that defines at least one characteristic of an operation of an industrial automation device in performance of an industrial automation process, transmitting the command from the containerized control application to an input/output (I/O) proxy, wherein the I/O proxy is configured to interface between the containerized control application and a physical I/O, transmitting the command from the I/O proxy to the physical I/O, wherein the physical I/O is configured to receive data from the industrial automation device and provide commands to the industrial automation device, transmitting the command from the physical I/O to the industrial automation device, and implementing, via the industrial automation device, the command.

In another embodiment, a system includes processing circuitry and memory, accessible by the processing circuitry. The memory stores instructions that, when executed by the processing circuitry, cause the processing circuitry to receive, via an input/output (I/O) proxy, from a containerized control application executing in a container running on computing infrastructure, a command that defines at least one characteristic of an operation of an industrial automation device in performance of an industrial automation process, and transmit the command, via the I/O proxy, to a physical I/O, wherein the physical I/O is configured to provide the command to the industrial automation device for implementation.

In a further embodiment, a non-transitory computer readable medium stores instructions that, when executed by processing circuitry, cause the processing circuitry to receive, via an input/output (I/O) proxy, from a physical I/O, data associated with an operation of an industrial automation device in performance of an industrial automation process wherein the I/O proxy is configured to interface between a containerized control application executing in a container running on computing infrastructure and the physical I/O, transmit, via the I/O proxy, the data to the containerized control application, analyze, via the containerized control application, the data, generate, via the containerized control application, a command adjusting at least one characteristic of the operation of the industrial automation device based on the analyzing of the data, provide, via the containerized control application, the command to the I/O proxy, and transmit, via the I/O proxy, the command to the physical I/O, wherein the physical I/O is configured to provide the command to the industrial automation device for implementation.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present embodiments will become better understood when the following detailed description is read with reference to the accompanying drawings in which like characters represent like parts throughout the drawings, wherein:

FIG. 1 is a schematic view of an industrial automation system, in accordance with embodiments presented herein;

FIG. 2 is a block diagram of example components that could be used in the industrial automation system of FIG. 1, in accordance with embodiments presented herein;

FIG. 3 is a perspective view of an example of the industrial automation system of FIG. 1 controlled by an industrial control system, in accordance with an embodiment;

FIG. 4 is a block diagram of an example operational technology (OT) network, including the industrial control system of FIG. 3, that coordinates with a container orchestration system, in accordance with an embodiment;

FIG. 5 is a schematic illustrating an architecture for containerized distributed control applications running on scalable compute that can be utilize to perform process control of the industrial automation systems of FIGS. 1, 3, and 4, in accordance with an embodiment;

FIG. 6 is a flow chart of a process for controlling an industrial automation device via the containerized control applications of FIG. 5, in accordance with an embodiment;

FIG. 7 is a flow chart of another process for controlling the industrial automation device via the containerized control applications of FIG. 5, in accordance with an embodiment; and

FIG. 8 is a flow chart of a process for performing a failover operation from a primary instantiation of the containerized control application of FIG. 5 to a backup instantiation of the containerized control application of FIG. 5, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Running process control for one or more industrial automation devices on dedicated OT hardware, such as a controller, is inflexible and hard to scale quickly. An operator's capability to run process control on dedicated hardware is largely limited to the capabilities of the OT hardware it has at its disposal and how that OT hardware is configured. Adding capability to run more process control may require acquiring more OT hardware. Correspondingly, reducing process control may result in underutilizing existing OT hardware. Moreover, shifting process control for the one or more industrial automation systems may utilize time and resources to reconfigure existing OT hardware. Accordingly, performing process control via containerized distributed control applications running on scalable compute may provide an operator with process control that is flexible and easy to scale to his or her needs.

For example, one or more industrial automation devices may be in communication with physical input/output (I/O). Process control for the one or more industrial automation devices may be performed, via the physical I/O, by one or more containerized control applications executing in one or more containers running on information technology (IT) infrastructure, such as one or more on-premises (“on-prem”) or remote servers, in the cloud, or some combination thereof. In some embodiments, the one or more containers may be configured to run on OT infrastructure (e.g., a compute surface of an industrial automation controller or an industrial automation device). The one or more containerized control applications may be configured such that data used by the one or more containerized control applications is stored on the infrastructure, separate from the one or more containerized control applications, such that the data may be accessible by multiple containerized control applications.

An I/O proxy layer acts as an interface between the one or more containerized control applications and the physical I/O. In some case, the I/O proxy layer may be software running on the IT infrastructure, whereas in other cases the I/O proxy layer may be a combination of hardware and software. In order to facilitate control of the one or more industrial automation devices by the containerized control applications, the I/O proxy layer may be high performance in terms of control speed and polling rates, while being reliable and deterministic. Accordingly, the I/O proxy layer may be configured to provide responses to requests in a timely manner, such that the I/O proxy layer can facilitate real-time communication between the containerized control applications and physical equipment (e.g., industrial automation controllers and/or industrial automation devices). This may be achieved, for example, using a 10-gigabit wired connection via fiberoptic cable, or in some other way. Accordingly, the containerized distributed process control may be well-suited for applications that do not require extremely fast response times.

To maintain reliability (e.g., failover and/or fault tolerance), the system may monitor and maintain an awareness of the one or more containerized control applications and/or the infrastructure on which they run such that if a problem is detected, the system can put itself into a safe state (e.g., by adjusting one or more control points) until the problem can be diagnosed and remedied. Further, the IT infrastructure may be configured such that a primary instantiation of the one or more containerized control applications run on-prem and failover to a backup cloud-based instantiation of the one or more containerized control applications, or a primary cloud-based instantiation of the one or more containerized control applications may failover to a backup on-prem instantiation of the one or more containerized control applications. In other embodiments, a primary on-prem instantiation of the one or more containerized control applications may failover to a backup on-prem instantiation of the one or more containerized control applications or a primary cloud-based instantiation of the one or more containerized control applications may failover to a backup cloud-based instantiation of the one or more containerized control applications.

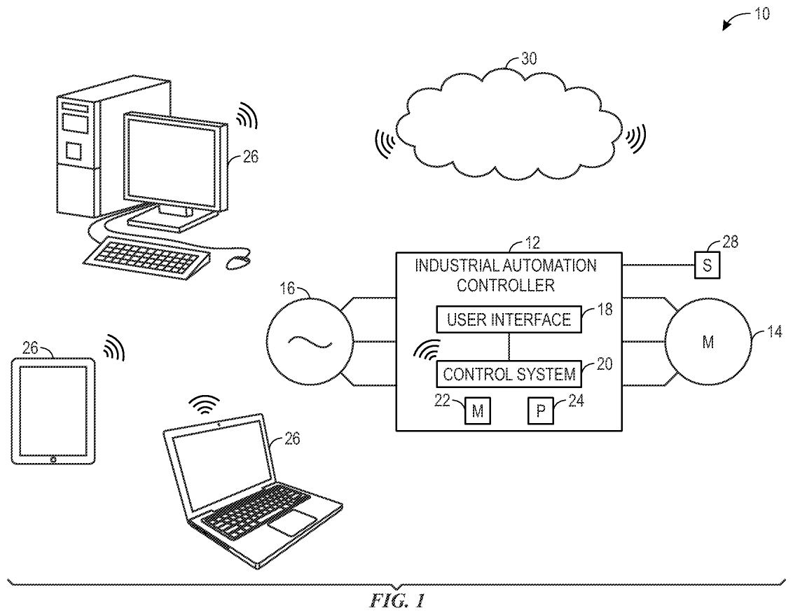

For ease of use, the specifics of how the containerized control applications are configured to run in containers on the IT infrastructure are automatically managed by a container orchestration system and do not need to be specified by the user unless the user wishes to define these aspects of the containerized distributed process control. Accordingly, a design engineer or an operator can design a containerized control application by focusing on control of the one or more industrial automation devices without concern for factors like which applications are running in what containers on which infrastructure, amount of data and/or memory usage, rigid cycle time, redundancy, high availability, etc., and then rely on a container orchestration system to figure out how to implement the containerized control application using the containerized distributed control applications running on scalable compute. The containerized control application could then be scaled automatically by the container orchestration system based on usage, providing load balancing, native fault tolerance, etc. Accordingly, the containerized distributed process control results in process control for industrial automation devices that is more flexible and scalable than running process control on dedicated OT hardware. Additional details with regard to containerized distributed process control in accordance with the techniques described above will be provided below with reference to FIGS. 1-8.

By way of introduction, FIG. 1 is a schematic view of an example industrial automation system 10 in which the embodiments described herein may be implemented. As shown, the industrial automation system 10 includes a controller 12 and an actuator 14 (e.g., a motor). The industrial automation system 10 may also include, or be coupled to, a power source 16. The power source 16 may include a generator, an external power grid, a battery, or some other source of power. The controller 12 may be a stand-alone control unit that controls multiple industrial automation components (e.g., a plurality of motors 14), a controller 12 that controls the operation of a single automation component (e.g., motor 14), or a subcomponent within a larger industrial automation system 10. In the instant embodiment, the controller 12 includes a user interface 18, such as a human machine interface (HMI), and a control system 20, which may include a memory 22 and a processor 24. The controller 12 may include a cabinet or some other enclosure for housing various components of the industrial automation system 10, such as a motor starter, a disconnect switch, etc.

The control system 20 may be programmed (e.g., via computer readable code or instructions stored on the memory 22, such as a non-transitory computer readable medium, and executable by the processor 24) to provide signals for controlling the motor 14. In certain embodiments, the control system 20 may be programmed according to a specific configuration desired for a particular application. For example, the control system 20 may be programmed to respond to external inputs, such as reference signals, alarms, command/status signals, etc. The external inputs may originate from one or more relays or other electronic devices. The programming of the control system 20 may be accomplished through software or firmware code that may be loaded onto the internal memory 22 of the control system 20 (e.g., via a locally or remotely located computing device 26) or programmed via the user interface 18 of the controller 12. The control system 20 may respond to a set of operating parameters. The settings of the various operating parameters may determine the operating characteristics of the controller 12. For example, various operating parameters may determine the speed or torque of the motor 14 or may determine how the controller 12 responds to the various external inputs. As such, the operating parameters may be used to map control variables within the controller 12 or to control other devices communicatively coupled to the controller 12. These variables may include, for example, speed presets, feedback types and values, computational gains and variables, algorithm adjustments, status and feedback variables, programmable logic controller (PLC) control programming, and the like.

In some embodiments, the controller 12 may be communicatively coupled to one or more sensors 28 for detecting operating temperatures, voltages, currents, pressures, flow rates, and other measurable variables associated with the industrial automation system 10. With feedback data from the sensors 28, the control system 20 may keep detailed track of the various conditions under which the industrial automation system 10 may be operating. For example, the feedback data may include conditions such as actual motor speed, voltage, frequency, power quality, alarm conditions, etc. In some embodiments, the feedback data may be communicated back to the computing device 26 for additional analysis.

The computing device 26 may be communicatively coupled to the controller 12 via a wired or wireless connection. The computing device 26 may receive inputs from a user defining an industrial automation project using a native application running on the computing device 26 or using a website accessible via a browser application, a software application, or the like. The user may define the industrial automation project by writing code, interacting with a visual programming interface, inputting or selecting values via a graphical user interface, or providing some other inputs. The user may use licensed software and/or subscription services to create, analyze, and otherwise develop the project. The computing device 26 may send a project to the controller 12 for execution. Execution of the industrial automation project causes the controller 12 to control components (e.g., motor 14) within the industrial automation system 10 through performance of one or more tasks and/or processes. In some applications, the controller 12 may be communicatively positioned in a private network and/or behind a firewall, such that the controller 12 does not have communication access outside a local network and is not in communication with any devices outside the firewall, other than the computing device 26. The controller 12 may collect feedback data during execution of the project, and the feedback data may be provided back to the computing device 26 for analysis. Feedback data may include, for example, one or more execution times, one or more alerts, one or more error messages, one or more alarm conditions, one or more temperatures, one or more pressures, one or more flow rates, one or more motor speeds, one or more voltages, one or more frequencies, and so forth. The project may be updated via the computing device 26 based on the analysis of the feedback data.

The computing device 26 may be communicatively coupled to a cloud server 30 or remote server via the internet, or some other network. In one embodiment, the cloud server 30 may be operated by the manufacturer of the controller 12, a software provider, a seller of the controller 12, a service provider, operator of the controller 12, owner of the controller 12, etc. The cloud server 30 may be used to help customers create and/or modify projects, to help troubleshoot any problems that may arise with the controller 12, develop policies, or to provide other services (e.g., project analysis, enabling, restricting capabilities of the controller 12, data analysis, controller firmware updates, etc.). The remote/cloud server 30 may be one or more servers operated by the manufacturer, software provider, seller, service provider, operator, or owner of the controller 12. The remote/cloud server 30 may be disposed at a facility owned and/or operated by the manufacturer, software provider, seller, service provider, operator, or owner of the controller 12. In other embodiments, the remote/cloud server 30 may be disposed in a datacenter in which the manufacturer, software provider, seller, service provider, operator, or owner of the controller 12 owns or rents server space. In further embodiments, the remote/cloud server 30 may include multiple servers operating in one or more data center to provide a cloud computing environment.

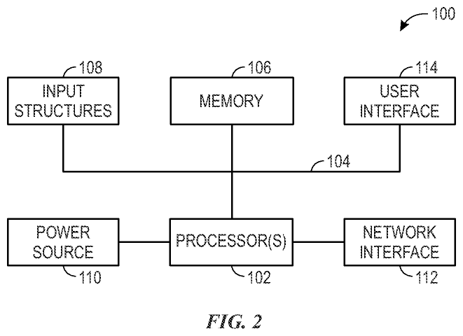

FIG. 2 illustrates a block diagram of example components of a computing device 100 that could be used as the computing device 26, the cloud/remote server 30, the controller 12, or some other device within the system 10 shown in FIG. 1. As used herein, a computing device 100 may be implemented as one or more computing systems including laptop, notebook, desktop, tablet, HMI, or workstation computers, as well as server type devices or portable, communication type devices, such as cellular telephones and/or other suitable computing devices.

As illustrated, the computing device 100 may include various hardware components, such as one or more processors 102, one or more busses 104, memory 106, input structures 108, a power source 110, a network interface 112, a user interface 114, and/or other computer components useful in performing the functions described herein.

The one or more processors 102 may include, in certain implementations, microprocessors configured to execute instructions stored in the memory 106 or other accessible locations. Alternatively, the one or more processors 102 may be implemented as application-specific integrated circuits (ASICs), field-programmable gate arrays (FPGAs), and/or other devices designed to perform functions discussed herein in a dedicated manner. As will be appreciated, multiple processors 102 or processing components may be used to perform functions discussed herein in a distributed or parallel manner.

The memory 106 may encompass any tangible, non-transitory medium for storing data or executable routines. Although shown for convenience as a single block in FIG. 2, the memory 106 may encompass various discrete media in the same or different physical locations. The one or more processors 102 may access data in the memory 106 via one or more busses 104.

The input structures 108 may allow a user to input data and/or commands to the device 100 and may include mice, touchpads, touchscreens, keyboards, controllers, and so forth. The power source 110 can be any suitable source for providing power to the various components of the computing device 100, including line and battery power. In the depicted example, the device 100 includes a network interface 112. Such a network interface 112 may allow communication with other devices on a network using one or more communication protocols. In the depicted example, the device 100 includes a user interface 114, such as a display that may display images or data provided by the one or more processors 102. The user interface 114 may include, for example, a monitor, a display, and so forth. As will be appreciated, in a real-world context a processor-based system, such as the computing device 100 of FIG. 2, may be employed to implement some or all of the present approach, such as performing the functions of the controller, the computing device 26, and/or the cloud/remote server 30 shown in FIG. 1, as well as other memory-containing devices.

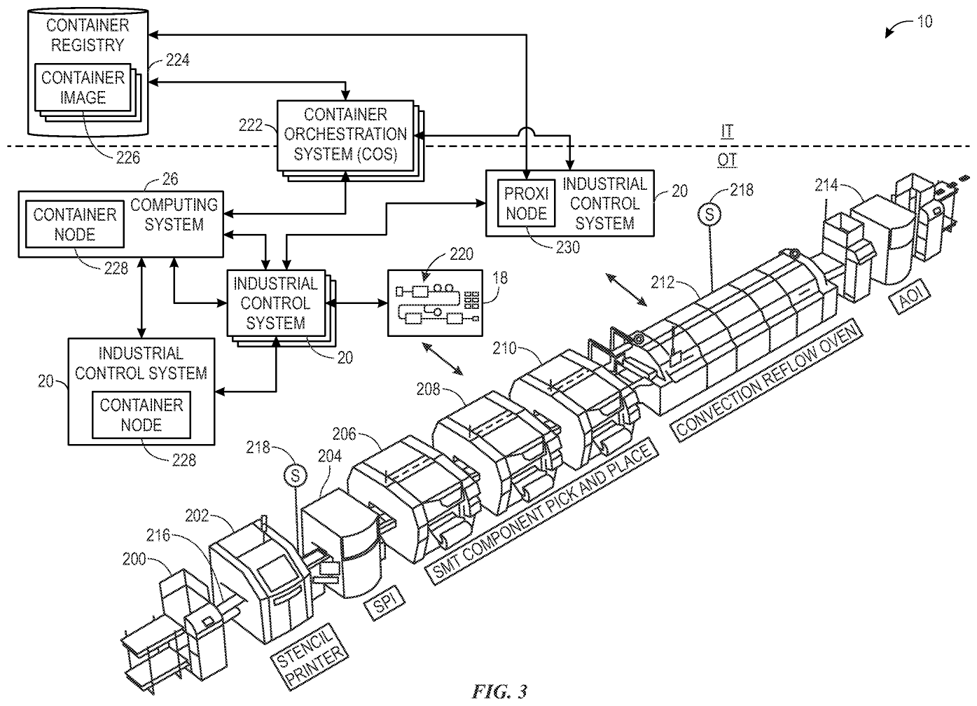

FIG. 3 is a perspective view of an example of the industrial automation system 10 of FIG. 1. The industrial automation system 10 includes stations 200, 202, 204, 206, 208, 210, 212, 214 having machine components and/or machines to conduct functions within an automated process, such as printed circuit board assembly, as is depicted. The automated process may begin at a station 200 used for loading objects, such as substrates, into the industrial automation system 10 via a conveyor section 216. For example, objects may be transported along the conveyor section 216 to station 202 to perform a first action, such a printing solder paste to the substrate via stenciling. As objects exit from the station 202, the objects may be transported via the conveyor section 216 to a station 204 for solder paste inspection (SPI) to inspect printer results, to a station 206, 208, and 210 for surface mount technology (SMT) component placement, to a station 212 for convection reflow oven to melt the solder to make electrical couplings, and finally to a station 214 for automated optical inspection (AOI) to inspect the object manufactured (e.g., the manufactured printed circuit board). After the objects proceed through the various stations, the objects may be removed from the station 214, for example, for storage in a warehouse or for shipment. It should be understood, however, that, for other applications, the particular system, machine components, machines, stations, and/or conveyors may be different or specially adapted to the application.

For example, the industrial automation system 10 may include machinery to perform various operations in a compressor station, an oil refinery, a batch operation for making food items, chemical processing operations, brewery operations, mining operations, a mechanized assembly line, and so forth. Accordingly, the industrial automation system 10 may include a variety of operational components, such as electric motors, valves, actuators, temperature elements, pressure sensors, or a myriad of machinery or devices used for manufacturing, processing, material handling, and other applications. The industrial automation system 10 may also include electrical equipment, hydraulic equipment, compressed air equipment, steam equipment, mechanical tools, protective equipment, refrigeration equipment, power lines, hydraulic lines, steam lines, and the like. Some example types of equipment may include mixers, machine conveyors, tanks, skids, specialized original equipment manufacturer machines, and the like. In addition to the equipment described above, the industrial automation system 10 may also include motors, protection devices, switchgear, compressors, and the like. Each of these described operational components may correspond to and/or generate a variety of OT data regarding operation, status, sensor data, operational modes, alarm conditions, or the like, that may be desirable to output for analysis with IT data from an IT network, for storage in an IT network, for analysis with expected operation set points (e.g., thresholds), or the like.

In certain embodiments, one or more properties of the industrial automation system 10 equipment, such as the stations 200, 202, 204, 206, 208, 210, 212, 214, may be monitored and controlled by the industrial control systems 20 for regulating control variables. For example, sensing devices (e.g., sensors 218) may monitor various properties of the industrial automation system 10 and may be used by the industrial control systems 20 at least in part in adjusting operations of the industrial automation system 10 (e.g., as part of a control loop). In some cases, the industrial automation system 10 may be associated with devices used by other equipment. For instance, scanners, gauges, valves, flow meters, and the like may be disposed on or within the industrial automation system 10. Here, the industrial control systems 20 may receive data from the associated devices and use the data to perform their respective operations more efficiently. For example, a controller of the industrial automation system 10 associated with a motor drive may receive data regarding a temperature of a connected motor and may adjust operations of the motor drive based on the data.

The industrial control systems 20 may include or be communicatively coupled to the display/operator interface 18 (e.g., a human-machine interface (HMI)) and to devices of the industrial automation system 10. It should be understood that any suitable number of industrial control systems 20 may be used in a particular industrial automation system 10 embodiment. The industrial control systems 20 may facilitate representing components of the industrial automation system 10 through programming objects that may be instantiated and executed to provide simulated functionality similar or identical to the actual components, as well as visualization of the components, or both, on the display/operator interface 18. The programming objects may include code and/or instructions stored in the industrial control systems 20 and executed by processing circuitry of the industrial control systems 20. The processing circuitry may communicate with memory circuitry to permit the storage of the component visualizations.

As illustrated, a display/operator interface 18 may be configured to depict representations 220 of the components of the industrial automation system 10. The industrial control system 20 may use data transmitted by the sensors 218 to update visualizations of the components via changing one or more statuses, states, and/or indications of current operations of the components. These sensors 218 may be any suitable device adapted to provide information regarding process conditions. Indeed, the sensors 218 may be used in a process loop (e.g., control loop) that may be monitored and controlled by the industrial control system 20. As such, a process loop may be activated based on process inputs (e.g., an input from the sensor 218) or direct input from a person via the display/operator interface 18. The person operating and/or monitoring the industrial automation system 10 may reference the display/operator interface 18 to determine various statuses, states, and/or current operations of the industrial automation system 10 and/or for a particular component. Furthermore, the person operating and/or monitoring the industrial automation system 10 may adjust to various components to start, stop, power-down, power-on, or otherwise adjust an operation of one or more components of the industrial automation system 10 through interactions with control panels or various input devices.

The industrial automation system 10 may be considered a data-rich environment with several processes and operations that each respectively generate a variety of data. For example, the industrial automation system 10 may be associated with material data (e.g., data corresponding to substrate or raw material properties or characteristics), parametric data (e.g., data corresponding to machine and/or station performance, such as during operation of the industrial automation system 10), test results data (e.g., data corresponding to various quality control tests performed on a final or intermediate product of the industrial automation system 10), or the like, that may be organized and sorted as OT data. In addition, sensors 218 may gather OT data indicative of one or more operations of the industrial automation system 10 or the industrial control system 20. In this way, the OT data may be analog data or digital data indicative of measurements, statuses, alarms, or the like associated with operation of the industrial automation system 10 or the industrial control system 20.

The industrial control systems 12 described above may operate in an OT space in which OT data is used to monitor and control OT assets, such as the equipment illustrated in the stations 200, 202, 204, 206, 208, 210, 212, 214 of the industrial automation system 10 or other industrial equipment. The OT space, environment, or network generally includes direct monitoring and control operations that are coordinated by the industrial control system 20 and a corresponding OT asset. For example, a programmable logic controller (PLC) may operate in the OT network to control operations of an OT asset (e.g., drive, motor, and/or high-level controllers). The industrial control systems 20 may be specifically programmed or configured to communicate directly with the respective OT assets.

A container orchestration system 222, on the other hand, may operate in an information technology (IT) environment. That is, the container orchestration system 222 may include a cluster of multiple computing devices that coordinates an automatic process of managing or scheduling work of individual containers for applications within the computing devices of the cluster. In other words, the container orchestration system 222 may be used to automate various tasks at scale across multiple computing devices. By way of example, the container orchestration system 222 may automate tasks such as configuring and scheduling deployment of containers, provisioning and deploying containers, determining availability of containers, configuring applications in terms of the containers that they run in, scaling of containers to equally balance application workloads across an infrastructure, allocating resources between containers, performing load balancing, traffic routing, and service discovery of containers, performing health monitoring of containers, securing the interactions between containers, and the like. In any case, the container orchestration system 222 may use configuration files to determine a network protocol to facilitate communication between containers, a storage location to save logs, and the like. The container orchestration system 222 may also schedule deployment of containers into clusters and identify a host (e.g., node) that may be best suited for executing the container. After the host is identified, the container orchestration system 222 may manage the lifecycle of the container based on predetermined specifications.

With the foregoing in mind, it should be noted that containers refer to technology for packaging an application along with its runtime dependencies. That is, containers include applications that are decoupled from an underlying host infrastructure (e.g., operating system). By including the run time dependencies with the container, the container may perform in the same manner regardless of the host in which it is operating. In some embodiments, containers may be stored in a container registry 224 as container images 226. The container registry 224 may be any suitable data storage or database that may be accessible to the container orchestration system 222. The container image 226 may correspond to an executable software package that includes the tools and data employed to execute a respective application. That is, the container image 226 may include related code for operating the application, application libraries, system libraries, runtime tools, default values for various settings, and the like.

By way of example, an integrated development environment (IDE) tool may be employed by a user to create a deployment configuration file that specifies a desired state for the collection of nodes of the container orchestration system 222. The deployment configuration file may be stored in the container registry 224 along with the respective container images 226 associated with the deployment configuration file. The deployment configuration file may include a list of different pods and a number of replicas for each pod that should be operating within the container orchestration system 222 at any given time. Each pod may correspond to a logical unit of an application, which may be associated with one or more containers. The container orchestration system 222 may coordinate the distribution and execution of the pods listed in the deployment configuration file, such that the desired state is continuously met. In some embodiments, the container orchestration system 222 may include a master node that retrieves the deployment configuration files from the container registry 224, schedules the deployment of pods to the connected nodes, and ensures that the desired state specified in the deployment configuration file is met. For instance, if a pod stops operating on one node, the master node may receive a notification from the respective worker node that is no longer executing the pod and deploy the pod to another worker node to ensure that the desired state is present across the cluster of nodes.

As mentioned above, the container orchestration system 222 may include a cluster of computing devices, computing systems, or container nodes that may work together to achieve certain specifications or states, as designated in the respective container. In some embodiments, container nodes 228 may be integrated within industrial control systems 20 as shown in FIG. 3. That is, container nodes 228 may be implemented by the industrial control systems 20, such that they appear as worker nodes to the master node in the container orchestration system 222. In this way, the master node of the container orchestration system 222 may send commands to the container nodes 228 that are also configured to perform applications and operations for the respective industrial equipment.

With this in mind, the container nodes 228 may be integrated with the industrial control systems 20, such that they serve as passive-indirect participants, passive-direct participants, or active participants of the container orchestration system 222. As passive-indirect participants, the container nodes 228 may respond to a subset of all of the commands that may be issued by the container orchestration system 222. In this way, the container nodes 228 may support limited container lifecycle features, such as receiving pods, executing the pods, updating a respective filesystem to included software packages for execution by the industrial control system 20, and reporting the status of the pods to the master node of the container orchestration system 222. The limited features implementable by the container nodes 228 that operate in the passive-indirect mode may be limited to commands that the respective industrial control system 20 may implement using native commands that map directly to the commands received by the master node of the container orchestration system 222. Moreover, the container node 228 operating in the passive-indirect mode of operation may not be capable to push the packages or directly control the operation of the industrial control system 20 to execute the package. Instead, the industrial control system 20 may periodically check the file system of the container node 228 and retrieve the new package at that time for execution.

As passive-direct participants, the container nodes 228 may operate as a node that is part of the cluster of nodes for the container orchestration system 222. As such, the container node 228 may support the full container lifecycle features. That is, container node 228 operating in the passive-direct mode may unpack a container image and push the resultant package to the industrial control system 20, such that the industrial control system 20 executes the package in response to receiving it from the container node 228. As such, the container orchestration system 222 may have access to a worker node that may directly implement commands received from the master node onto the industrial control system 20.

In the active participant mode, the container node 228 may include a computing module or system that hosts an operating system (e.g., Linux) that may continuously operate a container host daemon that may participate in the management of container operations. As such, the active participant container node 228 may perform any operations that the master node of the container orchestration system 222 may perform. By including a container node 228 operating in the OT space, the container orchestration system 222 is capable of extending its management operations into the OT space (e.g., the container node 228 may provision devices in the OT space).

A proxy node 230, which may be an instance of the container node 228 or a different container node 228, may provide bi-directional coordination between the IT space and the OT space, and the like. For instance, the container node 228 operating as the proxy node 230 may intercept orchestration commands and cause industrial control system 20 to implement appropriate machine control routines based on the commands. The industrial control system 20 may confirm the machine state to the proxy node 230, which may then reply to the master node of the container orchestration system 222 on behalf of the industrial control system 20.

Additionally, the industrial control system 20 may share an industrial automation device tree via the proxy node 230. As such, the proxy node 230 may provide the master node with state data, address data, descriptive metadata, versioning data, certificate data, key information, and other relevant parameters concerning the industrial control system 20. Moreover, the proxy node 230 may issue requests targeted to other industrial control systems 20 to control other industrial automation devices. For instance, the proxy node 230 may translate and forward commands to a target industrial automation device using one or more OT communication protocols, may translate and receive replies from the industrial automation device s, and the like. As such, the proxy node 230 may perform health checks, provide configuration updates, send firmware patches, execute key refreshes, and other OT operations for other industrial automation devices.

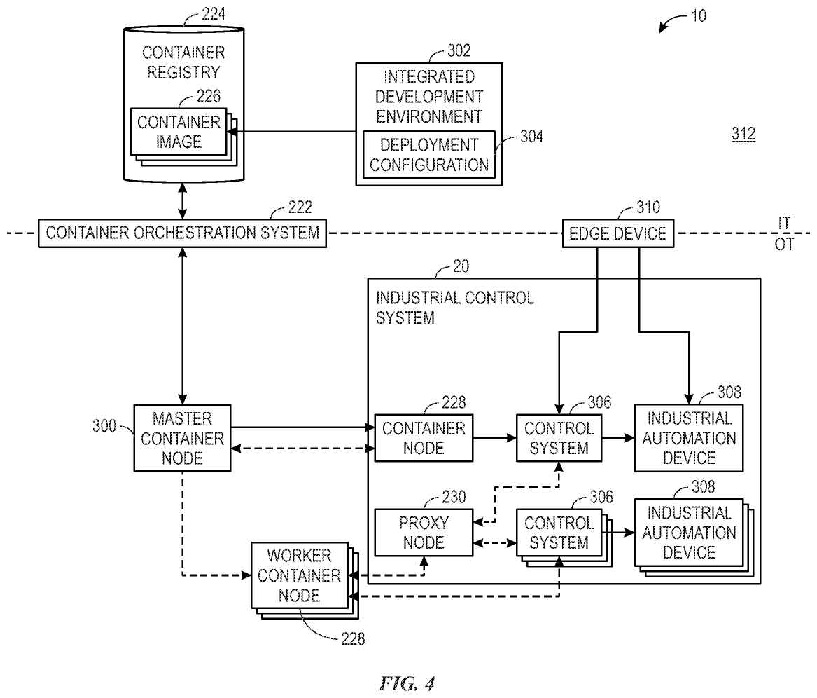

FIG. 4 illustrates a block diagram that depicts the relative positions of the container node 228 and the proxy node 230 with respect to the container orchestration system 222. As mentioned above, the container orchestration system 222 may include a collection of nodes that are used to achieve a desired state of one or more containers across multiple nodes. As shown in FIG. 4, the container orchestration system 222 may include a master node 300 that may execute control plane processes for the container orchestration system 222. The control plane processes may include the processes that enable the container orchestration system 222 to coordinate operations of the container nodes 228 to meet the desired states. As such, the master container node 300 may execute an applications programming interface (API) for the container orchestration system 222, a scheduler component, core resource controllers, and the like. By way of example, the master container node 300 may coordinate all of the interactions between nodes of the cluster that make up the container orchestration system 222. Indeed, the master container node 300 may be responsible for deciding the operations that will run on container nodes 228 including scheduling workloads (e.g., containerized applications), managing the workloads' lifecycle, scaling, and upgrades, managing network and storage resources for the workloads, and the like. The master container node 300 may run an API server to handle requests and status updates received from the container nodes 228.

By way of operation, an integrated development environment (IDE) tool 302 may be used by an operator to develop a deployment configuration file 304. As mentioned above, the deployment configuration file 304 may include details regarding the containers, the pods, constraints for operating the containers/pods, and other information that describe a desired state of the containers specified in the deployment configuration file 304. In some embodiments, the deployment configuration file 304 may be generated in a YAML file, a JSON file, or other suitable file format that is compatible with the container orchestration system 222. After the IDE tool 302 generates the deployment configuration file 304, the IDE tool 302 may transmit the deployment configuration file 304 to the container registry 224, which may store the file along with container images 226 representative of the containers stored in the deployment configuration file 304.

In some embodiments, the master container node 300 may receive the deployment configuration file 304 via the container registry 224, directly from the IDE tool 302, or the like. The master container node 300 may use the deployment configuration file 304 to determine a location to gather the container images 226, determine communication protocols to use to establish networking between container nodes 228, determine locations for mounting storage volumes, locations to store logs for the containers, and the like.

Based on the desired state provided in the deployment configuration file 304, the master container node 300 may deploy containers to the container host nodes 228. That is, the master container node 300 may schedule the deployment of a container based on constraints (e.g., CPU or memory availability) provided in the deployment configuration file 304. After the containers are operating on the container nodes 228, the master container node 300 may manage the lifecycle of the containers to ensure that the containers specified by the deployment configuration file 304 are operating according to the specified constraints and the desired state.

Keeping the foregoing in mind, the industrial control system 20 may not use an operating system (OS) that is compatible with the container orchestration system 222. That is, the container orchestration system 222 may be configured to operate in the IT space that involves the flow of digital information. In contrast, the industrial control system 20 may operate in the OT space that involves managing the operation of physical processes and the machinery used to perform those processes. For example, the OT space may involve communications that are formatted according to OT communication protocols, such as FactoryTalk LiveData, EtherNet/IP, Common Industrial Protocol (CIP), OPC Direct Access (e.g., machine to machine communication protocol for industrial automation developed by the OPC Foundation), OPC Unified Architecture (OPCUA), or any suitable OT communication protocol (e.g. DNP3, Modbus, Profibus, Lon Works, DALI, BACnet, KNX, EnOcean). Because the industrial control systems 20 operate in the OT space, the industrial control systems may not be capable of implementing commands received via the container orchestration system 222.

In certain embodiments, the container node 228 may be programmed or implemented in the industrial control system 20 to serve as a node agent that can register the industrial control system 20 with the master container node 300. The node agent may or may not be the same as the proxy node 230 shown in FIG. 3. For example, the industrial control system 20 may include a PLC that cannot support an operating system (e.g., Linux) for receiving and/or implementing requested operations issued by the container orchestration system 222. However, the PLC may perform certain operations that may be mapped to certain container events. As such, the container node 228 may include software and/or hardware components that may map certain events or commands received from the master container node 300 into actions that may be performed by the PLC. After converting the received command into a command interpretable by the PLC, the container node 228 may forward the mapped command to the PLC that may implement the mapped command. As such, the container node 228 may operate as part of the cluster of nodes that make up the container orchestration system 222, while a first control system 306 (e.g., PLC) that coordinates the OT operations for a second industrial automation device 308 in the industrial control system 12. The first control system 306 may include a controller, such as a PLC, an HLC, a programmable automation controller (PAC), or any other controller that may monitor, control, and operate an industrial automation device or component.

The industrial automation device 308 may correspond to an industrial automation device or component and may include any suitable industrial device that operates in the OT space. As such, the industrial automation device 308 may be involved in adjusting physical processes being implemented via the industrial system 10. In some embodiments, the industrial automation device 308 may include motors, contactors, starters, sensors, drives, relays, protection devices, switchgear, compressors. In addition, the industrial automation device 308 may also be related to various industrial equipment such as mixers, machine conveyors, tanks, skids, specialized original equipment manufacturer machines, and the like. The industrial automation device 308 may also be associated with devices used by the equipment such as scanners, gauges, valves, flow meters, and the like.

In the present embodiments described herein, the control system 306 may thus perform actions based on commands received from the container node 228. By mapping certain container lifecycle states into appropriate corresponding actions implementable by the control system 306, the container node 228 enables program content for the industrial control system 20 to be containerized, published to certain registries, and deployed using the master container node 300, thereby bridging the gap between the IT-based container orchestration system 222 and the OT-based industrial control system 20.

In some embodiments, the container node 228 may operate in an active mode, such that the container node may invoke container orchestration commands for other container nodes 228. For example, a proxy node 230 may operate as a proxy or gateway node that is part of the container orchestration system 222. The proxy node 230 may be implemented in a sidecar computing module that has an operating system (OS) that supports the container host daemon. In another embodiment, the proxy node 230 may be implemented directly on a core of the control system 306 that is configured (e.g., partitioned), such that the control system 306 may operate using an operating system that allows the container node 228 to execute orchestration commands and serve as part of the container orchestration system 222. In either case, the proxy node 230 may serve as a bi-directional bridge for IT/OT orchestration that enables automation functions to be performed in IT devices based on OT data and in industrial automation control systems 306 and industrial automation devices 308 based on IT data. For instance, the proxy node 230 may acquire industrial automation device tree data, state data for an industrial automation device, descriptive metadata associated with corresponding OT data, versioning data for industrial automation control systems 306 and industrial automation devices 308, certificate/key data for the industrial automation device, and other relevant OT data via OT communication protocols. The proxy node 230 may then translate the OT data into IT data that may be formatted to enable the master container node 300 to extract relevant data (e.g., machine state data) to perform analysis operations and to ensure that the container orchestration system 222 and the connected control systems 306 are operating at the desired state. Based on the results of its scheduling operations, the master container node 300 may issue supervisory control commands to targeted industrial automation device via the proxy nodes 230, which may translate and forward the translated commands to the respective control system 306 via the appropriate OT communication protocol.

In addition, the proxy node 230 may also perform certain supervisory operations based on its analysis of the machine state data of the respective control system 306. As a result of its analysis, the proxy node 230 may issue commands and/or pods to other nodes that are part of the container orchestration system 222. For example, the proxy node 230 may send instructions or pods to other worker container nodes 228 that may be part of the container orchestration system 222. The worker container nodes 228 may corresponds to other container nodes 228 that are communicatively coupled to other control systems 306 for controlling other industrial automation devices 308. In this way, the proxy node 230 may translate or forward commands directly to other control systems 306 via certain OT communication protocols or indirectly via the other worker container nodes 228 associated with the other control systems 306. In addition, the proxy node 230 may receive replies from the control systems 306 via the OT communication protocol and translate the replies, such that the nodes in the container orchestration system 222 may interpret the replies. In this way, the container orchestration system 222 may effectively perform health checks, send configuration updates, provide firmware patches, execute key refreshes, and provide other services to industrial automation devices 308 in a coordinated fashion. That is, the proxy node 230 may enable the container orchestration system to coordinate the activities of multiple control systems 306 to achieve a collection of desired machine states for the connected industrial automation devices 308.

As shown in FIG. 4, the industrial automation system 10 may include one or more edge devices 310 that interact with OT assets 306, 308 within the industrial automation system 10. As used herein, an “edge device” 310 is a device within the industrial automation system 10 that controls data flow within the industrial automation system 10 (e.g., the OT network) as well as between the industrial automation system 10 (e.g., the OT network) and an IT network 312. For example, the edge device 310 may be a router, a switch, or the like. In certain embodiments, the edge device 310 may receive data from the network 312 that may include, for example, an enterprise system, a server device, a plant management system, or the like. The enterprise system may include software and/or hardware components that support business processes, information flows, reporting, data analytics, and the like for an enterprise. The server device may manage communication between the components of the industrial automation system 10. The plant management system may include any suitable management computing system that receives data from a number of control systems (e.g., industrial control systems 20). As such, the plant management system may track operations of one or more facilities and one or more locations. In addition, the plant management system may issue control commands to the components of the industrial automation system 10.

As previously described, running process control for one or more industrial automation devices 308 exclusively via dedicated OT hardware, such as the industrial automation controllers 12 shown in in FIG. 1, the industrial control systems 20 shown in FIGS. 1 and 3, and the control systems 306 shown in FIG. 4, is inflexible as well as being slow and expensive to scale. Specifically, an operator's capability to run process control on dedicated hardware is largely limited to the hardware it has at its disposal, the capabilities of the OT hardware it has at its disposal, and how that OT hardware is configured. As such, adding capability to run more process control or increasing capacity to run process control may require acquiring more OT hardware. Correspondingly, reducing process control capability may result in underutilizing existing OT hardware. Moreover, shifting process control for the one or more industrial automation systems may utilize time and resources to move and/or reconfigure existing OT hardware. Accordingly, by using containerized distributed control applications running on scalable compute to perform some or all of an enterprise's or a facility's process control may provide an operator with process control that is flexible and easy to scale to his or her needs.

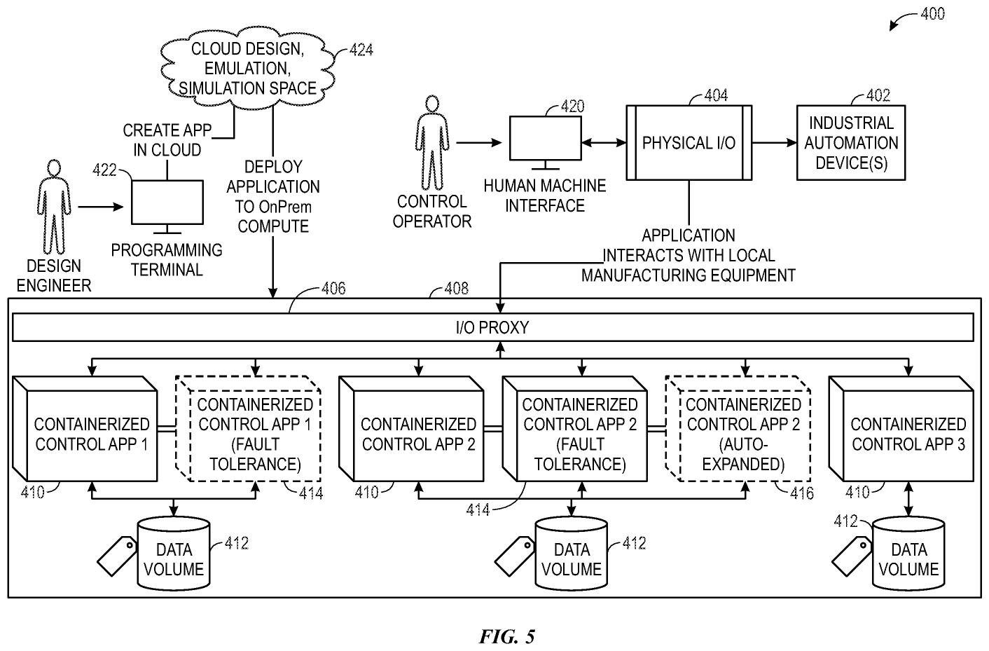

With this in mind, FIG. 5 is a schematic illustrating an architecture 400 for containerized distributed control applications running on scalable compute that can be utilized to perform process control. As shown, one or more industrial automation devices 402 of one or more industrial automation systems work together to perform one or more industrial automation processes (e.g., printed circuit board (PCB) assembly, as shown in FIG. 3). For example, the industrial automation device may include a variety of operational components, such as motors, contactors, starters, relays, protection devices, switchgear, compressors, valves, actuators, temperature elements, pressure sensors, mixers, machine conveyors, tanks, skids, specialized original equipment manufacturer machines, or a myriad of machinery or devices used for manufacturing, processing, material handling, and other applications. Industrial automation devices may also include, for example, electrical equipment, hydraulic equipment, compressed air equipment, steam equipment, mechanical tools, protective equipment, refrigeration equipment, power lines, hydraulic lines, steam lines, and the like.

The one or more industrial automation devices 402 may be communicatively coupled to physical input/output (I/O) 404, which may be configured to receive data from the one or more industrial automation devices 402 and to provide signals to the one or more industrial automation devices 402. Whereas the physical I/O 404 would typically be communicatively coupled to physical OT hardware, such as one or more industrial automation controllers, in the embodiment illustrated in FIG. 5, the physical I/O 404 is communicatively coupled to an I/O proxy layer 406. For example, the physical I/O 404 may be configured to receive data (e.g., commands) from the I/O proxy 406 according to a network protocol and control the industrial automation devices 402 based on the received data, and/or convert the received data and output a signal to the industrial automation devices 402 by a command provided via a hardwired connection. Similarly, the physical I/O 404 may be configured to receive data from the industrial automation devices 402 via the hardwired connection, and then convert and output the date to the I/O proxy 406 according to the network protocol being used.

In some embodiments, the I/O proxy layer 406, may be instantiated as software running on computing infrastructure 408 (e.g., IT infrastructure, such as a server, a workstation computing device, a desktop computing device, a laptop computing device, a tablet, or a mobile device, a dedicated interface, such as a human-machine interface (HMI) or a human interface module (HIM), OT infrastructure, such as an industrial automation controller, a drive, etc., a compute surface of an IT or OT device, and so forth). In other embodiments, the I/O proxy layer 406 may be a separate piece of hardware (e.g., including a processor and a memory) configured to run software that defines its operation. The I/O proxy layer 406 acts as an interface between the physical I/O 404 and one or more containerized control applications 410. For example, the I/O proxy layer 406 receives data (e.g., data indicative of one or more characteristics of the operation of the one or more industrial automation devices 402) from the physical I/O 404 and transmits the data to one or more respective containerized control applications 410 associated with the one or more industrial automation devices 402. Further, the I/O proxy layer 406 receives data (e.g., control commands, configuration changes, etc.) from the one or more containerized control applications 410 and provides data to the physical I/O 404 for transmission to the one or more industrial automation devices 402.

The I/O proxy layer 406 may be considered to be high performance in terms of speed and polling rates. For example, the I/O proxy layer 406 may have high control speeds, high data transmission speeds, and also high performance with respect to requested packet intervals (RPIs), while maintaining reliability and determinism. For example, the I/O proxy layer 406 may be configured to respond to requests in a timely manner (e.g., less than 1 second, less than 0.5 seconds, less than 0.1 seconds, less than .01 seconds, less than a millisecond, etc.), such that the I/O proxy layer 406 is capable of facilitating “real-time” communication between the one or more containerized control applications 410 and physical equipment (e.g., one or more respective industrial automation devices 402). Accordingly, the I/O proxy layer 406 has similar or improved performance relative to an available backplane serial bus in terms of reliability, performance, speed, and determinism. To achieve these goals, the computing infrastructure 408 may be communicatively coupled to the physical I/O 404 via a wired connection, such as a 10 gigabit ethernet connection, a fiberoptic connection, and so forth.

As previously described, process control may be performed via the containerized control applications 410 executing in containers running on the computing infrastructure 408 instead of on physical OT hardware, such as a controller. In some embodiments the computing infrastructure 408 includes IT infrastructure, such as servers. However, embodiments are also envisaged in which the computing infrastructure 408 includes other types of computing infrastructure, such as one or more compute surfaces of an industrial automation controller or industrial automation device, one or more tablets, one or more mobile devices, one or more computers, and so forth. For example, in embodiments in which process control is performed via a containerized control application 410 executing in a container running on a compute surface of a controller, the controller may be configured to perform traditional control of a first industrial automation device and then have a compute surface running a container executing a containerized control application 410 that provides control of a second industrial automation device 402. This configuration may be particularly well suited to situations in which an operator wishes to be able to control one or more additional industrial automation devices without acquiring additional OT hardware. Though previous discussion of the computing infrastructure 408 has discussed on-premises (on-prem) embodiments, it should be understood that embodiments are also envisaged in which the computing infrastructure 408 includes cloud and/or remote servers.

As shown in FIG. 5, the computing infrastructure 408 may store data and/or metadata used by the containerized control applications 410 in data stores 412 that are separate from the containerized control applications 410, such that data from the data stores 412 may be accessible by multiple containerized control applications 410 simultaneously. Data stored in the data stores 412 may include tag data, configuration data, log data, and so forth. In embodiments in which the computing infrastructure 408 includes both on-prem infrastructure and cloud/remote infrastructure, one or more data stores 412 may be separated from the containerized control applications 410 that use data from the data stores 412, such that the containerized control applications 410 may run on the on-prem infrastructure while the data stores 412 are on cloud/remote infrastructure (e.g., so the data stores 412 may be accessible to containerized control applications 410 running on on-prem infrastructure in multiple locations). Further, embodiments are also envisaged in which the data stores 412 are on on-prem infrastructure and the containerized control applications 410 run on cloud/remote infrastructure.

Along these lines, as will be described in more detail below, the computing infrastructure 408 may run primary instantiations of the containerized control applications 410, as well as backup instantiations of the containerized control applications 414, and/or auto-expanded instantiations of the containerized control applications 416, which may be distributed across on-prem infrastructure and cloud/remote infrastructure. Accordingly, primary instantiations of the containerized control applications 410 may be configured to failover from the on-prem infrastructure to backup instantiations of the containerized control applications 414 on the cloud/remote infrastructure or failover from primary instantiations of the containerized control applications 410 running on the cloud-based infrastructure to backup instantiations of the containerized control applications 414 running on the on-prem infrastructure. As part of the failsafe and/or fault-tolerant capabilities of the architecture 400, the system may monitor various components of the architecture 400 to maintain and awareness of the liveness of various components of the system (e.g., the containerized control applications 410, 414, 416, the computing infrastructure 408, the I/O proxy 406, the physical I/O 404, and one or more industrial automation devices 402, etc.), as well as the system as a whole. Accordingly, if one or more of the components fails, or the system as a whole fails, the system (e.g., via the containerized control applications 410, the I/O proxy 406, the physical I/O 404, and/or the one or more industrial automation devices 402) may set control points to some safe state (e.g., a state that a designer or operator has designated as “safe” such that the system is known to be safe within the designated state) such that additional damage does not occur. For example, machinery may be configured to stop moving or stop processes that could lead to over-heating or over-pressurizing when certain conditions are detected. Additionally, or alternatively, in some embodiments, or a relief valve, or some other safety mechanism, may be actuated to a defined position to avoid over-heating or over-pressurizing when certain conditions are detected. Further, the I/O proxy 406 and/or the container orchestration system shown and described with regard to FIGS. 3 and 4 may be configured to redirect communication from the primary instantiations of the containerized control applications 410, and/or the auto-expanded instantiations of the containerized control applications 416, to the backup instantiations of the containerized control applications 414.

Primary instantiations of the containerized control applications 410 running on a first infrastructure (e.g., a first node, on-prem, cloud/remote, etc.) may access one or more auto-expanded instantiations of the containerized control applications 416 running on a second infrastructure (e.g., a second node, on-prem, cloud/remote, etc.) if, for example, computing resources of the first infrastructure are limited. Accordingly, the containerized control applications 410 may be scaled (e.g., expanded and/or condensed) automatically based on usage, available computing resources, etc. to provide automatic load balancing. In some embodiments, the scaling of the containerized control applications 410 (e.g., managing auto-expanded instantiations of the containerized control applications 416) and fault-tolerant/failover aspects of the containerized control applications 410 (e.g., managing backup instantiations of the containerized control applications 414, performing failover operations, etc.) may be performed by the container orchestration system shown and described with regard to FIGS. 3 and 4 in a way that is opaque to a design engineer or a control operator.

For example, a control operator may monitor and/or control the operation of the industrial automation devices 402 via a human machine interface (HMI) communicatively coupled to the physical I/O 404. The control operator may be entirely unaware that the container orchestration system has configured one or more containerized control applications 410, including one or more auto-expanded instantiations of the containerized control applications 416, and one or more backup instantiations of the containerized control applications 414, which may be distributed across computing infrastructure that may include multiple nodes on-prem, in the cloud, remote, and so forth.

Similarly, a design engineer may design/program a control application via a programming terminal 422 without specifying how the control application is executed by one or more containers, including auto-expanded instantiations of the control application, backup instantiations of the control application, and so forth. Accordingly, because the container orchestration system can take care of how to distribute a workload over a set of containers, the design engineer can design the control applications without having to consider data/memory usage, tag usage, rigid cycle time, redundancy, high availability, etc. However, if the design engineer wishes, the design engineer may have the capability to specify how the control application is executed by one or more containers, how instantiations of the control application are auto-expanded, how backup instantiations of the control application are generated and maintained, and so forth. The programming terminal 422 may include any computing device (e.g., a workstation computer, a desktop computer, a laptop computer, a tablet, a mobile device, a dedicated interface, such as a HIM or an HMI, and so forth) running a native application or a web application that acts as a design environment for designing control applications. In the embodiment shown in FIG. 5, the design environment is a cloud environment 424 that allows the design engineer to design the control application, as well as perform emulations and simulations to develop and test the control application before deployment to the computing infrastructure. However, in some embodiments, the design environment may be partially or entirely based on-prem (e.g., on a server or on the computing device used by the design engineer), or on a remote server.

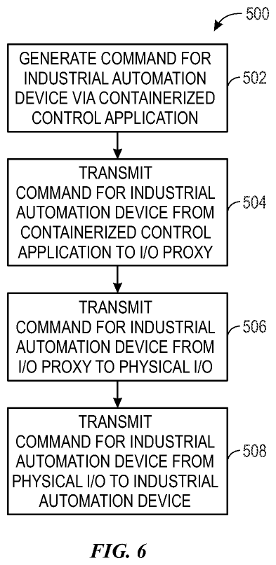

FIG. 6 is a flow chart of a process 500 for controlling an industrial automation device via a containerized control application. At block 502, a command is generated for the industrial automation device via the containerized control application. The command may be related to some aspect of the operation of the industrial automation device, a command to change/update a configuration, and so forth. For example, the command may be to start a process, stop a process, adjust an operational parameter, change a set point, change a threshold value, enter a safe state, enter a low power or energy-saving state, etc.

At block 504, the process 500 transmits the command for the industrial automation device from the containerized control application to the I/O proxy. As previously described, in some embodiments, the I/O proxy may be software running on the computing infrastructure. In such embodiments, if the computing infrastructure is distributed across one or more on-prem nodes, one or more cloud nodes, and/or one or more remote nodes, the I/O proxy software may include instantiations running on a single node, all the nodes, or a subset of the nodes. Accordingly, block 504 may include transmitting the command from one node of the computing infrastructure to one or more other nodes of the computing infrastructure. In such embodiments, the I/O proxy may facilitate transmission of the command between nodes of the computing infrastructure via the one or more instantiations of the I/O proxy.

Correspondingly, in other embodiments the I/O proxy may be a piece of hardware (e.g., having a processor and a memory) configured to run software stored in the memory to perform the various functions of the I/O proxy. In such embodiments, the I/O proxy may also include a network interface (as shown in FIG. 2), or some other way of communicating with the computing infrastructure running the containerized control applications. For example, the I/O proxy may include a wired connection (e.g., ethernet, fiberoptic) or a wireless connection. As with the software embodiment of the I/O proxy described above, if the computing infrastructure is distributed across one or more on-prem nodes, one or more cloud nodes, and/or one or more remote nodes, the I/O proxy may include may include a single I/O proxy hardware instantiation communicatively coupled to all of the nodes, multiple I/O proxy hardware instantiations, each coupled to one or more of the nodes, or a single I/O proxy hardware instantiation for each of the multiple nodes. Accordingly, block 504 may include transmitting the command from one node of the computing infrastructure, which may be equipped with its own I/O proxy hardware device, to one or more other nodes of the computing infrastructure, which may be equipped with their own I/O proxy hardware devices. In such embodiments, the I/O proxy may facilitate transmission of the command between nodes of the computing infrastructure via the one or more I/O proxy hardware devices.

At block 506, the process 500 transmits the command for the industrial automation device from the I/O proxy to the physical I/O. In embodiments in which an industrial automation system having multiple industrial automation devices has multiple physical I/O, the block 506 may include identifying (e.g., by the I/O proxy) which of the physical I/O is associated with the industrial automation device for which the command is intended and transmitting the command to the identified physical I/O.

At block 508, the process 500 transmits the command for the industrial automation device from the physical I/O to the industrial automation device. In embodiments in which the physical I/O is communicatively coupled to multiple industrial automation devices, block 508 may include identifying which of the industrial automation devices the command is intended and transmitting the command to the identified industrial automation device. The command may then be received and implemented by the industrial automation device.

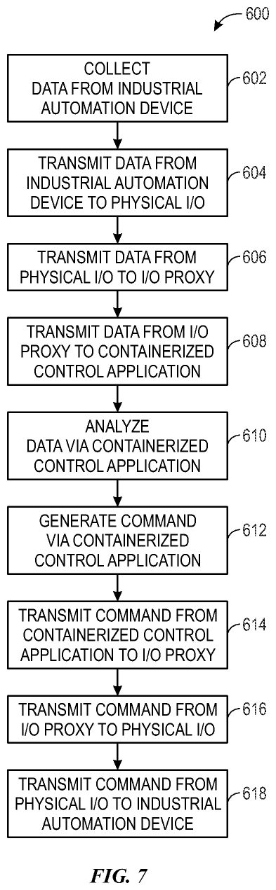

FIG. 7 is a flow chart of a process 600 for controlling an industrial automation device via a containerized control application. At block 602, data is collected from or by the industrial automation device. The collected data may be sensor data, actuator data, control signal data, set point data, data representative of the process being performed, alert/alarm data, fault code data, quality control data, position data, speed data, acceleration data, voltage date, current data, power data, force data, strain data, imaging data, audio data, thermal data, and so forth. The data may be generated by the industrial automation device, collected by the industrial automation device, collected by another device near the industrial automation device and received by the industrial automation device, or come into the possession of the industrial automation device in some other way.

At block 604, the process 600 transmits the data from the industrial automation device to the physical I/O. In some embodiments, upon receiving the data, the physical I/O may do some processing or pre-processing of the received data. For example, the physical I/O may be configured to convert the data from one protocol to another, filter data, compress data, and so forth.

At block 606, the process 600 transmits the data from the physical I/O to the I/O proxy. If the I/O proxy is on-prem, the transmission may be via a wired connection, such as an ethernet or fiberoptic connection. If the I/O proxy is in the cloud, the physical I/O may be cloud connected and have the ability to transmit the data to the I/O proxy in the cloud. In some embodiments, physical I/O may transmit the data to a local on-prem instantiation I/O proxy, which may then transmit the data to another (e.g., cloud/remote) instantiation of the I/O proxy.

At block 608, the process 600 transmits the data from the I/O proxy to the containerized control application. As previously discussed, the I/O proxy may transmit the data between nodes of the computing infrastructure in order to reach the appropriate containerized control application. Further, if the containerized control application has been expanded, one or more backup instantiations of the containerized control application have been created, or a failover operation has been performed such that a backup instantiation of the containerized control application is acting as the primary application, the I/O proxy may transmit the data to the one or more appropriate containerized control applications.

At block 610, the process 600 analyzes the data via the containerized control application. At block 612, the process 600, if the containerized control application determines that a command should be generated, generates a command for the industrial automation device. The command may be, for example to start a process, stop a process, adjust an operational parameter, change a set point, change a threshold value, enter a safe state, enter a low power or energy-saving state, etc.

At block 614, the process 600 transmits the command from the containerized control application to the I/O proxy. If the I/O proxy includes software running on the computing infrastructure, block 614 may include transmitting the command from one node of the computing infrastructure to one or more other nodes of the computing infrastructure. In such embodiments, the I/O proxy may facilitate transmission of the command between nodes of the computing infrastructure via the one or more instantiations of the I/O proxy. If the I/O proxy is one or more pieces of hardware, block 614 may include transmitting the command from one node of the computing infrastructure, which may be equipped with its own I/O proxy hardware device, to one or more other nodes of the computing infrastructure, which may be equipped with their own I/O proxy hardware devices. In such embodiments, the I/O proxy may facilitate transmission of the command between nodes of the computing infrastructure via the one or more I/O proxy hardware devices.

At block 616, the process 600 transmits the command from the I/O proxy to the physical I/O. In embodiments in which an industrial automation system having multiple industrial automation devices has multiple physical I/O, the block 616 may include identifying (e.g., by the I/O proxy) which of the physical I/O is associated with the industrial automation device for which the command is intended and transmitting the command to the identified physical I/O.

At block 618, the process 600 transmits the command for the industrial automation device from the physical I/O to the industrial automation device. In embodiments in which the physical I/O is communicatively coupled to multiple industrial automation devices, block 618 may include identifying which of the industrial automation devices the command is intended and transmitting the command to the identified industrial automation device. The command may then be received and implemented by the industrial automation device.

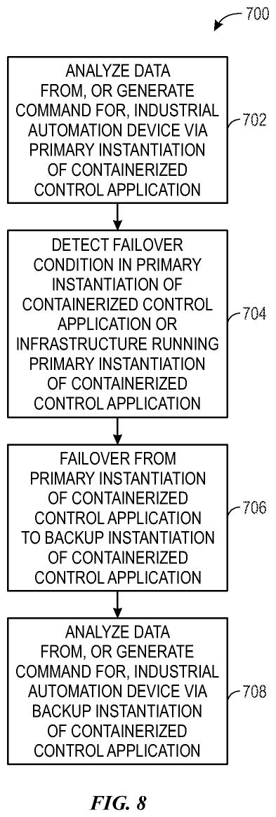

FIG. 8 is a flow chart of a process 700 for performing a failover operation from a primary instantiation of a containerized control application to a backup instantiation of the containerized control application. At block 702, the process 700 analyzes data from and industrial automation device, or generates a command for the industrial automation device, via a primary instantiation of a containerized control application and/or an auto-expanded instantiation of the containerized control application. As previously discussed, the primary instantiation of the containerized control application and the auto-expanded instantiation of the containerized control application may be located on-prem, in the cloud, on a remote server, or some combination thereof.

If data is analyzed, the data may be sensor data, actuator data, control signal data, set point data, data representative of the process being performed, alert/alarm data, fault code data, quality control data, position data, speed data, acceleration data, voltage date, current data, power data, force data, strain data, imaging data, audio data, thermal data, and so forth. The data may be generated by the industrial automation device, collected by the industrial automation device, collected by another device near the industrial automation device, or come from some other source.

If a command is generated, the command may be related to some aspect of the operation of the industrial automation device, a command to change/update a configuration, and so forth. For example, the command may be to start a process, stop a process, adjust an operational parameter, change a set point, change a threshold value, enter a safe state, enter a low power or energy-saving state, etc.

At block 704, the process 700 detects a failover condition. The failover condition may be a condition of the primary instantiation of the containerized control application, a condition of the computing infrastructure on which the primary instantiation of the containerized control applications runs, a condition of the I/O proxy, a condition of the physical I/O, a condition of the industrial automation device, or some other component of the industrial automation system and/or the supporting IT or OT infrastructure. The failover condition may be detected based on a characteristic of the primary instantiation of the containerized control application, a characteristic of the computing infrastructure on which the primary instantiation of the containerized control applications runs, a characteristic of the I/O proxy, a characteristic of the physical I/O, a characteristic of the industrial automation device, or some other component of the industrial automation system and/or the supporting IT or OT infrastructure. Such conditions and/or characteristics may be identified, for example, by the I/O proxy or by some other component within the system.

At block 706, the process 700 (e.g., via the I/O proxy) performs a failover operation from the primary instantiation of a containerized control application and/or an auto-expanded instantiation of the containerized control application to a backup instantiation of the containerized control application. The failover operation may include, for example, redirecting communication from the primary instantiations of the containerized control applications, and/or the auto-expanded instantiations of the containerized control applications, to the backup instantiations of the containerized control applications.

In some embodiments, the failover operation may include shifting data stores, and/or identifying data missing from the backup instantiation of the containerized control application that may have been received and/or generated since the instantiations of the containerized control applications were last synchronized, and providing the missing data to the backup instantiation of the containerized control application. Further, the failover operation may include assessing a status of, or processes being run by, the primary instantiation of the containerized control application and/or the auto-expanded instantiation of the containerized control application and providing an indication to the backup instantiation of the containerized control application.

As previously discussed, the failover operation may include shifting operations between nodes of the computing infrastructure. For example, operations may be moved from one node of on-prem computing infrastructure to a second node of on-prem computing infrastructure, from on-prem computing infrastructure to cloud-based computing infrastructure, from on-prem computing infrastructure to remote computing infrastructure, from cloud-based computing infrastructure to on-prem computing infrastructure, from a first node of cloud-based computing infrastructure to a second node of cloud-based computing infrastructure, from cloud-based computing infrastructure to remote computing infrastructure, from remote computing infrastructure to on-prem computing infrastructure, from remote computing infrastructure to cloud-based computing infrastructure, and/or from a first node of remote computing infrastructure to a second node of remote computing infrastructure, or some combination thereof.

In some embodiments, the failover operation may be performed in a way that is not noticeable by the user. If the failover condition includes one or more of the industrial automation devices, and/or the physical I/O, the failover operation may also include putting one or more of the industrial automation devices and/or the physical I/O into a safe state.

At block 708, the process 700 analyzes data from and industrial automation device, or generates a command for the industrial automation device, via the backup instantiation of a containerized control application. As previously discussed, this block may also include operating one or more of the industrial automation devices and/or the physical I/O in a safe state.

Running process control for one or more industrial automation devices on dedicated OT hardware, such as a controller, is inflexible and hard to scale quickly. An operator's capability to run process control on dedicated hardware is largely limited to the capabilities of the OT hardware it has at its disposal and how that OT hardware is configured. Adding capability to run more process control may require acquiring more OT hardware. Correspondingly, reducing process control may result in underutilizing existing OT hardware. Moreover, shifting process control for the one or more industrial automation systems may utilize time and resources to reconfigure existing OT hardware. Accordingly, performing process control via containerized distributed control applications running on scalable compute may provide an operator with process control that is flexible and easy to scale to his or her needs.

For example, one or more industrial automation devices may be in communication with physical input/output (I/O). Process control for the one or more industrial automation devices may be performed, via the physical I/O, by one or more containerized control applications executing in one or more containers running on information technology (IT) infrastructure, such as one or more on-premises (“on-prem”) or remote servers, in the cloud, or some combination thereof. In some embodiments, the one or more containers may be configured to run on OT infrastructure (e.g., a compute surface of an industrial automation controller or an industrial automation device). The one or more containerized control applications may be configured such that data used by the one or more containerized control applications is stored on the infrastructure, separate from the one or more containerized control applications, such that the data may be accessible by multiple containerized control applications.

An I/O proxy layer acts as an interface between the one or more containerized control applications and the physical I/O. In some case, the I/O proxy layer may be software running on the IT infrastructure, whereas in other cases the I/O proxy layer may be a combination of hardware and software. In order to facilitate control of the one or more industrial automation devices by the containerized control applications, the I/O proxy layer may be high performance in terms of control speed and polling rates, while being reliable and deterministic. Accordingly, the I/O proxy layer may be configured to provide responses to requests in a timely manner, such that the I/O proxy layer can facilitate real-time communication between the containerized control applications and physical equipment (e.g., industrial automation devices). This may be achieved, for example, using a 10-gigabit wired connection via fiberoptic cable, or in some other way. Accordingly, the containerized distributed process control may be well-suited for applications that do not require extremely fast response times.

To maintain reliability (e.g., failover and/or fault tolerance), the system may monitor and maintain an awareness of the one or more containerized control applications and/or the infrastructure on which they run such that if a problem is detected, the system can put itself into a safe state (e.g., by adjusting one or more control points) until the problem can be diagnosed and remedied. Further, the IT infrastructure may be configured such that a primary instantiation of the one or more containerized control applications run on-prem and failover to a backup cloud-based instantiation of the one or more containerized control applications, or a primary cloud-based instantiation of the one or more containerized control applications may failover to a backup on-prem instantiation of the one or more containerized control applications. In other embodiments, a primary on-prem instantiation of the one or more containerized control applications may failover to a backup on-prem instantiation of the one or more containerized control applications or a primary cloud-based instantiation of the one or more containerized control applications may failover to a backup cloud-based instantiation of the one or more containerized control applications.

For ease of use, the specifics of how the containerized control applications are configured to run in containers on the IT infrastructure are automatically managed by a container orchestration system and do not need to be specified by the user unless the user wishes to define these aspects of the containerized distributed process control. Accordingly, a design engineer or an operator can design a containerized control application by focusing on control of the one or more industrial automation devices without concern for factors like which applications are running in what containers on which infrastructure, amount of data and/or memory usage, rigid cycle time, redundancy, high availability, etc., and then rely on a container orchestration system to figure out how to implement the containerized control application using the containerized distributed control applications running on scalable compute. The containerized control application could then be scaled automatically by the container orchestration system based on usage, providing load balancing, native fault tolerance, etc. Accordingly, the containerized distributed process control results in process control for industrial automation devices that is more flexible and scalable than running process control on dedicated OT hardware.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A method, comprising:
generating, via a containerized control application executing in a container running on computing infrastructure, a command that defines at least one characteristic of an operation of an industrial automation device in performance of an industrial automation process;
transmitting the command from the containerized control application to an input/output (I/O) proxy, wherein the I/O proxy is configured to interface between the containerized control application and a physical I/O;
transmitting the command from the I/O proxy to the physical I/O, wherein the physical I/O is configured to receive data from the industrial automation device and provide commands to the industrial automation device;
transmitting the command from the physical I/O to the industrial automation device; and
implementing, via the industrial automation device, the command.

2. The method of claim 1, wherein the I/O proxy comprises software running on the computing infrastructure.

3. The method of claim 1, wherein the I/O proxy is separate from the computing infrastructure and comprises processing circuitry and memory, accessible by the processing circuitry, the memory storing instructions, executable by the processing circuitry, that define operation of the I/O proxy.

4. The method of claim 1, wherein the computing infrastructure is on-premises.

5. The method of claim 1, wherein the containerized control application comprises a primary instantiation of the containerized control application, wherein an auto-expanded instantiation of the containerized control application executes in an additional container running on the computing infrastructure.

6. The method of claim 1, wherein the containerized control application comprises a primary instantiation of the containerized control application executing in the container running on a first node of the computing infrastructure, wherein a backup instantiation of the containerized control application executes in an additional container running on a second node of the computing infrastructure.

7. The method of claim 6, comprising:
detecting a failover condition experienced by the primary instantiation of the containerized control application, the container, the computing infrastructure, the I/O proxy, the physical I/O, or the industrial automation device, or any combination thereof; and
in response to detecting the failover condition, performing a failover operation from the primary instantiation of the containerized control application to the backup instantiation of the containerized control application.

8. The method of claim 7, comprising, in response to detecting the failover condition, putting the industrial automation device in a safe state.

9. The method of claim 1, comprising:
collecting the data from the industrial automation device, wherein the data is associated with the operation of the industrial automation device in the performance of the industrial automation process;
transmitting the collected data from the industrial automation device to the physical I/O;
transmitting the collected data from the physical I/O to the I/O proxy;
transmitting the collected data from the I/O proxy to the containerized control application;
analyzing, via the containerized control application, the collected data;
generating, via the containerized control application, an additional command adjusting at least one characteristic of the operation of the industrial automation device based on the analyzing of the data;
transmitting, the additional command from the containerized control application to the I/O proxy;
transmitting the additional command from the I/O proxy to the physical I/O;
transmitting the additional command from the physical I/O to the industrial automation device; and
implementing, via the industrial automation device, the additional command to adjust the at least one characteristic of the operation of the industrial automation device.

10. A system, comprising:
processing circuitry; and
memory, accessible by the processing circuitry, the memory storing instructions that, when executed by the processing circuitry, cause the processing circuitry to perform actions comprising:
receiving, via an input/output (I/O) proxy, from a containerized control application executing in a container running on computing infrastructure, a command that defines at least one characteristic of an operation of an industrial automation device in performance of an industrial automation process; and
transmitting the command, via the I/O proxy, to a physical I/O, wherein the physical I/O is configured to provide the command to the industrial automation device for implementation.

11. The system of claim 10, wherein the system comprises the computing infrastructure, wherein the actions comprise:
generating, via the containerized control application, the command; and
transmitting the command from the containerized control application to the I/O proxy.

12. The system of claim 10, wherein the computing infrastructure is separate from the system.

13. The system of claim 10, wherein the actions comprise:
receiving, via the I/O proxy, from the physical I/O, data associated with the operation of the industrial automation device in the performance of the industrial automation process;
transmitting, via the I/O proxy, the received data to the containerized control application;
receiving, via the I/O proxy, from the containerized control application, an additional command adjusting the at least one characteristic of the operation of the industrial automation device based on an analysis of the data; and
transmitting, via the I/O proxy, the additional command to the physical I/O, wherein the physical I/O is configured to provide the additional command to the industrial automation device for implementation.

14. The system of claim 10, wherein the containerized control application comprises a primary instantiation of the containerized control application executing in the container running on a first node of the computing infrastructure, wherein a backup instantiation of the containerized control application executes in an additional container running on a second node of the computing infrastructure, wherein the actions comprise:
detecting a failover condition experienced by the primary instantiation of the containerized control application, the container, the computing infrastructure, the I/O proxy, the physical I/O, or the industrial automation device, or any combination thereof; and
in response to detecting the failover condition, performing a failover operation from the primary instantiation of the containerized control application to the backup instantiation of the containerized control application.

15. The system of claim 14, wherein the actions comprise, in response to detecting the failover condition, transmitting, via the I/O proxy, an additional command to the physical I/O to put the industrial automation device in a safe state.

16. A non-transitory computer readable medium storing instructions that, when executed by processing circuitry, cause the processing circuitry to perform actions comprising:
receiving, via an input/output (I/O) proxy, from a physical I/O, data associated with an operation of an industrial automation device in performance of an industrial automation process wherein the I/O proxy is configured to interface between a containerized control application executing in a container running on computing infrastructure and the physical I/O;
transmitting, via the I/O proxy, the data to the containerized control application;
analyzing, via the containerized control application, the data;
generating, via the containerized control application, a command adjusting at least one characteristic of the operation of the industrial automation device based on the analyzing of the data;
providing, via the containerized control application, the command to the I/O proxy; and
transmitting, via the I/O proxy, the command to the physical I/O, wherein the physical I/O is configured to provide the command to the industrial automation device for implementation.

17. The non-transitory computer readable medium of claim 16, wherein the containerized control application comprises a primary instantiation of the containerized control application, wherein an auto-expanded instantiation of the containerized control application executes in an additional container running on the computing infrastructure.

18. The non-transitory computer readable medium of claim 16, wherein the containerized control application comprises a primary instantiation of the containerized control application executing in the container running on a first node of the computing infrastructure, wherein a backup instantiation of the containerized control application executes in an additional container running on a second node of the computing infrastructure.

19. The non-transitory computer readable medium of claim 18, wherein the first node and the second node are on-premises.

20. The non-transitory computer readable medium of claim 18, wherein the first node is on-premises and the second node is cloud-based.
